(19) United States
(12) Patent Application Publication
(10) Pub. No.: US 2003/0131343 A1
(43) Pub. Date: Jul. 10, 2003

(54) Framework for system monitoring

(76) Inventors: Ronan J. French, Lucan (IE); David C. Tracey, Monasterboice (IE); Jay B. Brandenburg, Atherton, CA (US)

Correspondence Address: WILLIAMS, MORGAN & AMERSON, P.C., 10333 RICHMOND, SUITE 1100, HOUSTON, TX, 77042, US

(21) Appl. No.: 10/012,594

(22) Filed: Oct. 19, 2001

(51) Int. Cl. G06F 9/44

(52) U.S. Cl. 717/127; 717/115

(57) ABSTRACT

The present invention is an extensible framework for monitoring the operation of a computing system and, in some implementations, to manage the computer system. The invention includes a method for use in monitoring the operation of a computing system. A monitoring module definition in a predefined syntax is inserted into a configuration file, a monitoring module in accordance with the definition is encoded, and a script directing a read of the configuration file is encoded. The monitoring module definition specifies a module name identifying the location for the monitoring module, a monitoring function to be executed at a period, an event triggering the monitoring function, and an action to be taken depending on the outcome of the event. The monitoring module includes a validation function in the location and the specified monitoring function in the location.

### BACKGROUND OF THE INVENTION

1. Field of the Invention

The present invention pertains to the administration of computing systems, and, more particularly, a framework for monitoring the performance of a computing system.

2. Description of the Related Art

The ever-increasing power and sophistication of modern computing systems carries an ever-increasing price in complexity. Modem computing systems permit many users to share many computing resources spread over extremely large geographical areas. Perhaps most familiarly, the Internet allows literally millions of people to access data across all the continents without regard to physical location or time zone. However, many large organizations implement and operate computing systems, sometimes referred to as “enterprise systems,” of similarly impressive scale. In many ways, the enterprise systems are more complex than the Internet. Enterprise systems typically operate under tighter performance criteria, have more demanding resource usage, and incorporate more complicated security measures, among other factors.

This complexity can quickly overwhelm the capabilities of an individual, or even a group of individuals, to maintain efficient operation. Consider, for instance, the question of resource usage. Many complex computing systems have multiple central processing units (“CPUs”), whose efficient usage is an important factor in the operation of the system. Each of these CPUs vies for access to system resources, such as memory. Furthermore, there may be different types of memory used for different purposes and/or for different kinds of data. The management of this and other resources greatly impacts efficiency. Frequently, however, these types of tasks are simply too complicated and/or transient to be adequately controlled by any person. So, system architects have developed automated tools for these tasks.

System architects have developed numerous such automated tools for managing the operation of complex computing systems. Ironically, these automated tools have, in some respects, increased complexity and difficulty in the management task. The typical management tool is very focused and monitors for the occurrence of some predetermined event. When the event occurs, it sends an automated message that is logged and ultimately reviewed by an administrator. The tool does not attempt to diagnose the underlying problem, and so merely reports a symptom and not the ill. Diagnosing the underlying problem remains the province of the administrator. However, even a simple problem can generate many events that, in turn, generate many messages.

The administrator reviews the messages and attempts to diagnose the problem. The number of messages generated is not necessarily related to the complexity or significance of the underlying problem. Sometimes the problem is significant enough that the system, or some part of it, must be shut down and re-booted. Sometimes the problem starts out minor, but becomes significant during the time in which the administrator is trying to diagnose the problem so that a re-boot becomes necessary. However, the administrator has no reliable way to gauge the likelihood of either eventuality. The messages are too diverse, and are not ordered in meaningful way. In short, the automated monitoring system is insufficiently integrated to facilitate the diagnosis once the report is logged.

Perhaps an even more egregious shortcoming of the automated monitoring tools is their limitation to monitoring. Many conditions of interest, once diagnosed, can be readily cured. But, as discussed above, the diagnosis of the problem and the curative response is handled manually. The lag between logging the message and implementing a curative response frequently exacerbates a small problem into a large problem. If the problem could be diagnosed in an automated fashion, and the curative response likewise automated, many minor problems could be addressed before they become significant.

Automated administration could also mitigate one of the most pressing issues facing any owner of large computing systems—an acute shortage of people technically qualified to administer them. The explosion in information technology engendered by the proliferation of powerful computing systems has outstripped the workforce's ability to produce qualified administrators. The shortage further exacerbates the problems set forth above associated with manual review of logged messages and diagnosis of underlying problems. Thus, manual administration, even with the help of automated tools, leaves much to be desired.

### SUMMARY OF THE INVENTION

The present invention is an extensible framework for monitoring the operation of a computing system and, in some implementations, to manage the computer system. The present invention manifests itself in a number of ways, as is illustrated more fully in the detailed description below.

In a first aspect, the invention includes a method for use in monitoring the operation of a computing system. The method comprises defining a monitoring module in a configuration file, the monitoring module definition specifying, according to a predefined syntax, a module name identifying a location, a monitoring function to be executed at a period, an event triggering the monitoring function, and an action to be taken depending on the outcome of the event. The method also includes encoding a monitoring module into a storage at the identified location. This further includes encoding a validation function and encoding the monitoring function. The method also includes scripting a read of the configuration file.

Thus, in a second aspect, the invention includes a computing system comprising a configuration file, a location, and a script directing a read of the configuration file. The configuration file includes at least one monitoring module definition specifying, according to a predefined syntax, a module name, a monitoring function to be executed at a period, an event triggering the monitoring function; and an action to be taken depending on the outcome of the event. A monitoring module according to the definition is encoded at the location identified by the specified module name includes a validation function and the specified monitoring function. The computing system also includes a script directing a read of the configuration file.

In a third aspect, the invention includes a method for monitoring the operation of a computing system. This method includes reading a configuration file including at least one monitoring module definition according to a predefined syntax; setting a plurality of variables in accordance with the specification of the monitoring module definitions; and executing a monitoring module defined by the monitoring module definition. Executing the monitoring module further includes executing a monitoring function specified by the monitoring module definition from within the monitoring module upon the occurrence of an event specified in the monitoring module definition; and executing a validation function from within the monitoring module upon instantiation of the variables.

Still other aspects of the invention include computers programmed to perform such methods and program storage devices encoded with instructions that, when executed by computing device, perform such methods.

### BRIEF DESCRIPTION OF THE DRAWINGS

The invention may be understood by reference to the following description taken in conjunction with the accompanying drawings, in which like reference numerals identify like elements, and in which:

FIG. 1A depicts an electronic computing device programmed and operated in accordance with one particular embodiment of the present invention;

FIG. 1B conceptually illustrates the hardware architecture of the electronic computing device of FIG. 1A in a partial block diagram;

FIG. 2 conceptually illustrates selected portions of the software architecture of the computing device of FIG. 1A and FIG. 1B; and

FIG. 3 depicts a computing system including the computing device of FIG. 1A, FIG. 1B, and FIG. 2 in one particular embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

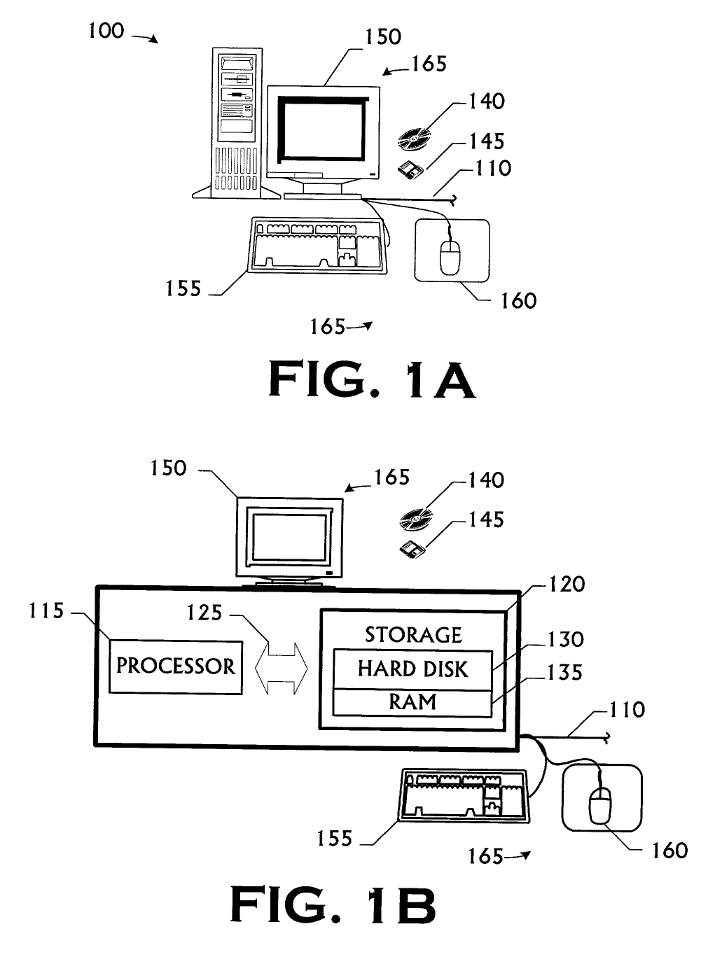

FIG. 1A depicts a computing device 100 programmed and operated in accordance with the present invention. The hardware architecture of the computing device 100 relevant to the present invention is illustrated in FIG. 1B. Some aspects of the hardware and software architecture (e.g., the individual cards, the basic input/output system (“BIOS”), input/output drivers, etc.) are not shown. These aspects are omitted for the sake of clarity, and so as not to obscure the present invention. As will be appreciated by those of ordinary skill in the art having the benefit of this disclosure, however, the software and hardware architectures of the computing device 100 will include many such routine features.

In the illustrated embodiment, the computing device 100 is a Sun UltraSPARC server (e.g., the Sun Ray™, Enterprise™ or Fire™ line of servers) employing a UNIX-based operating system (e.g., a Solaris™ OS) commercially available from the assignee of this application, Sun Microsystems, Inc. However, the invention is not so limited. The invention may be implemented in virtually any computing device, including those running under alternative operating systems.

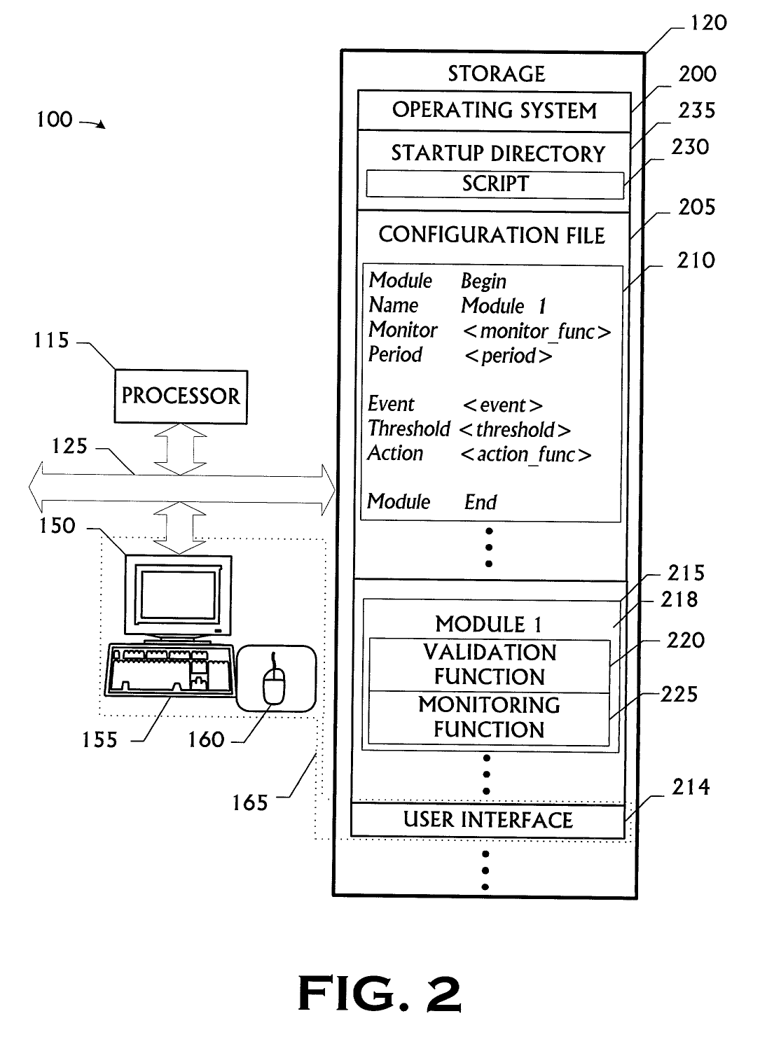

The computing device 100 also includes a processor 115 communicating with some storage 120 over a bus system 125. The storage 120 will typically include at least a hard disk 130 and some random access memory (“RAM”) 135. The computing device 100 may also, in some embodiments, include removable storage such as an optical disk 140, or a floppy electromagnetic disk 145, or some other form such as a magnetic tape or a zip disk (not shown). The processor 115 may be any suitable processor known to the art. For instance, the processor may be a microprocessor or a digital signal processor (“DSP”). In the illustrated embodiment, the processor 115 is an UltraSPARC™ 64-bit processor available from Sun Microsystems, but the invention is not so limited. The microSPARC™ from Sun Microsystems, any of the Itanium™ or Pentium™-class processors from Intel Corporation, the Athlon™ or Duron™ class processors from Advanced Micro Devices, Inc., and the Alpha™ processor from Compaq Computer Corporation might be employed. The computing device 100 includes a monitor 150, keyboard 155, and a mouse 160, which together, along with their associated user interface software 214 (shown in FIG. 2) comprise a user interface 165.

FIG. 2 illustrates selected portions of the software architecture of the computing device 100 shown in FIG. 1A and FIG. 1B. The storage 120 is encoded with the operating system 200, a configuration file 205 including a monitoring module definition 210, and a location 215. The monitoring module definition 210 implements a syntax described more fully below and specifies a module name, i.e., Module 1 in this embodiment, in accordance with that syntax. The specified module name in the monitoring module definition 210 identifies the location 215 in the storage 120 at which a monitoring module 218 is located. The monitoring module 218 contains a validation function 220 and a monitoring function 225 whose roles are discussed more fully below.

As mentioned, the illustrated embodiment is implemented in a UNIX operating system environment, and the location 215 is, in this particular embodiment, a “relative directory.” The location 215 is “relative” in that its location is specified by the module name relative to the monitoring module 218. As will be appreciated by those in the art having the benefit of this disclosure, a “relative directory” is a characteristic of the UNIX operating system environment not employed by all operating systems. Thus, in alternative embodiments, the location 215 may be implemented using any suitable portion of the storage 120.

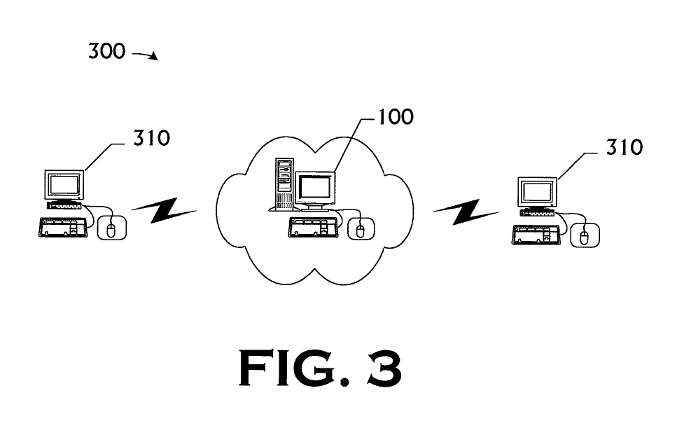

The computing device 100 typically comprises a portion of a larger computing system 300, shown in FIG. 3, by a connection over the line 110, shown in FIG. 1A and FIG. 1B. The computing system 300 may be a local area network (“LAN”), a wide area network (“WAN”), a system area network (“SAN”), an intranet, or even the Internet. The invention is not limited by this aspect of the computing system 300. The computing system 300 may implement any kind of architecture, i.e., a client/server architecture or a peer-to-peer architecture. The computing devices 310, in this particular embodiment, are Sun UltraSPARC workstations (e.g., the Sun Blade™ or the Ultra™ line of workstations) employing a UNIX-based operating system (e.g., a Solaris™ OS) commercially available from the assignee of this application, Sun Microsystems, Inc. However, the computing devices 310 may be implemented in virtually any type of electronic computing device such as a laptop computer, a desktop computer, a mini-computer, a mainframe computer, or a supercomputer, or even a peripheral device. The computing device 100 communicates with the computing devices 310 over communications links 320, which may be twisted wire pairs, coaxial cable, optical fiber, or some other suitable transmission medium known to the art. In some embodiments, the communications links 320 may even be wireless. The invention is not limited by these aspects of any given implementation.

The operation and/or resource usage of the computing system 300 is monitored through the operating systems 200's execution of functions specified by one or more monitoring modules 218. Each of the computing devices 310 may also be programmed with operating modules 218 that are the same or different from those of the computing device 100. Under the control of the operating modules 218, the computing system 300 manages itself without the need for remote system. For example, a memory monitor implemented by an operating module 218 may have an action to stop the application(s) using the most memory when certain thresholds have been detected as exceeded by the monitoring function defined by the operating module 218. Both the action and the thresholds are defined in the memory module definition 210 in the configuration file 205. The computing system 300 manages itself per the configuration files and installed monitoring scripts of the present invention.

Which operations and or resources are monitored is specified in monitoring module definition(s) 210 and implemented in the monitoring module(s) 218. The monitoring modules 218 may used to monitor for instance, the usage of swap space, the usage of central processing unit (“CPU”) time, the presence of rogue processes, the presence of resource-hogging processes, the usage of disk space, etc. The syntax for the configuration of the monitoring module definition(s) 210 in the configuration file 205 in this particular embodiment is defined as:

| ############################# | |
|---|---|
| Module | Begin |
| Name | <module_name> |
| Monitor | <monitor_func> |
| Period | <period> |
| Event | <event> |
| Threshold | <threshold> |
| Action | <action_func> |
| Module | End |

#############################

where:

<module_name> specifies the location (i.e., the location 215 in the illustrated embodiment) of the monitor functionality, action functionality, and validation;

<monitor_func> specifies the function that is run periodically and sets Boolean variables corresponding to module events to true or false;

<period> specifies the period at which the monitor function is run;

<event> is used with other entries in the configuration file to create appropriate variables used by the modules integrated under the framework;

<threshold> defines a threshold value that may be used, e.g., in determining whether to take subsequent action; and

<action_func> denotes a function to be executed conditioned upon the outcome of the specified <event>.

The specified <event> is unique within the configuration file 205 and the monitoring module 218 may specify several of these in any given implementation. The specified <threshold> is optional, and may be omitted in some implementations depending on the nature of the specified <monitor_func>. Most monitoring functions, however, will implicate such a threshold, which will be implementation specific. The specified <threshold> may be hardcoded or calculated on the fly by a called function (if pre-pended by the word “function”).

Note that the syntax admits wider variation within the context of the invention. For instance, in some embodiments, a module can specify variables for its own use:

| ############################# | |
|---|---|
| Module | Begin |
| Name | <module_name> |
| Monitor | <monitor_func> |
| Period | <period> |
| Event | <event> |
| Threshold | <threshold> |
| Action | <action_func> |
| <variable name> | <variable value> |
| Module | End |

#############################

where the variable <variable name> can be any variable and <variable value> can be any value for the particular variable. In the illustrated embodiment, the variable <variable name> is a Korn shell variable in the UNIX operating system environment. However, as will be appreciated by those in the art having the benefit of this disclosure, other types of operating systems may not employ Korn shells or shell variables, and so other types of variables may be used in alternative embodiments.

Some embodiments may also specify multiple events, as was mentioned above:

| ############################# | |
|---|---|
| Module | Begin |
| Name | <module_name> |
| Monitor | <monitor_func> |
| Period | <period> |
| Event | <event1> |
| Threshold | <threshold> |
| Action | <action_func> |
| Event | <event2> |
| Action | <action_func> |
| Module | End |

#############################

Note that the event <event2> has no threshold defined. Embodiments may employ multiple modules each specifying a single event, a single module specifying multiple events, or some combination of the two. In embodiments employing multiple modules, some may specify a single event while others specify multiple events, some may define thresholds while others do not, and some may define variables while others do not.

When the configuration file 205, including the monitoring module definition 210 per the defined syntax, and the monitoring module 218, including the validation function 220 and the monitoring function 225, are written into the storage 120, a script 230 is also written into the startup directory 235 in this particular embodiment. Note that the location of the script 230 is not material to the invention. For instance, a pointer (not shown) to the script 230 could be written into the startup directory 235 and the script 230 written elsewhere. The script 230 is then, in this particular embodiment, invoked at startup. Upon invocation, the script 230 reads the configuration file 205. In one particular embodiment, the script 230 re-reads the configuration upon the trap of a hang-up (“HUP”) signal. On reading the configuration file, the script 230 sets the variables per module (e.g., period, monitor function, etc.) and per event (e.g., event name, threshold, action, etc.). The operating system 200 then performs accordingly, i.e., invoking the specified functions at the specified intervals, etc.

Consider a monitoring module 218 to help manage a swap space, the monitoring module 218 defined by the following definition 210:

###########################################################

| Module | Begin | |
|---|---|---|
| Name | swap | |
| Monitor | monitor_{—} | |
| | swap | |
| Period | 1 minute | |
| Event | SwapLow | |
| Threshold | 98 | # percent swap used |
| Action | log_event send_alert | |
| | kill_swap_hogs | |
| PerProcess | 200 | #Mb virtual memory |
| VMThreshold | | threshold per process |

| | |
|---|---|
| Module | End |

#############################################################

In accordance with this module, the operating system will check every minute to see if the swap space is running too low. The variable Threshold indicates that the remaining swap space is too low if 98% of the swap space is in use. If the swap space is running too low, the event SwapLow is true, in which case the functions (in the monitoring module 218) log_event, send_alert, and kill_swap_hogs are called to log the event, send an alert to a user, and to terminate processes that are consuming too much of the swap space, respectively. The variable PerProcessVMThreshold defines a “swap hog” as any process consuming 200 Mb or more of virtual memory space.

In the illustrated embodiment, at the time the script 230 is run, the module swap module is located and instantiated. The location 215 identified by the module name swap includes at least the functions monitor_swap and validate_swap:

function monitor_swap {

SwapLow=false
#do system check
SystemCheckResult=$( check the % swap used on the system)
if [[$SystemCheckResult > $SwapLowThreshold]]

SwapLow=true

fi
return 0

}
function validate_swap {

#
# SwapLowThreshold must be a % in the range 50-99%
#
[[$SwapLowThreshold ! = [5-9] [0-9[[[ && Return 1
return 0

}

The function monitor_swap:

first sets SwapLow false;

calls the function SystemCheckResult to determine the amount of the swap space used;

compares the value returned from the function SystemCheckResult against the value of the variable SwapLowThreshold (defined in the module and passed to the function monitor_swap);

if the value returned by the function SystemCheckResult exceeds that assigned to the variable SwapLowThreshold, then SwapLow is set to “true”; and

returns.

The function validate_swap checks the value of SwapLowThreshold and returns a value of 1 if it ranges between 50-99%, inclusive, and returns a value of 0 otherwise.

As was mentioned above, the specified <threshold> may be calculated on the fly. Modifying the swap monitoring module definition 210 discussed above appropriately, the new monitoring module definition 210 would then be:

| ############################################# | |
|---|---|
| Module | Begin |
| Name | swap |
| Monitor | monitor_swap |
| Period | 180 minutes |
| Event | SwapLow |
| Threshold | function calculate_swap_threshold |
| Action | log_event send_alert kill_swap_hogs |
| Module | End |

###############################################

Thus, a framework for monitoring the entire computing system 300 can be established by defining in the configuration file 205 and inserting in the storage 120 one or more modules 218 per the defined syntax, the modules 218 specifying one or more functions selected for that purpose. The operating system 200 then implements these modules 218 in a daemon that runs in the background of the computing system 300's operation. The framework can be “hidden” in the sense that the monitoring, once set up, occurs in the background of the system's operation. The number of specified events and the number of modules will be implementation specific depending on the thoroughness of the desired monitoring. This framework is then employed to monitor selected resources and services, to detect errors, and to initiate self-recovery mechanisms directed to remedying any detected problems.

Note that some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for use in monitoring the operation of a computing system, comprising:
defining a monitoring module in a configuration file, the monitoring module definition specifying, according to a predefined syntax:
a module name identifying a location;
a monitoring function to be executed at a period;
an event triggering the monitoring function; and
an action to be taken depending on the outcome of the event;
encoding a monitoring module into a storage at the identified location, including:
encoding a validation function; and
encoding the monitoring function; and
scripting a read of the configuration file.

2. The method of claim 1, wherein the monitoring module definition specifies the period.

3. The method of claim 1, wherein the monitoring module definition further specifies a threshold.

4. The method of claim 3, wherein the threshold is hardcoded or calculated on the fly by a called function.

5. The method of claim 1, wherein the event comprises one of a plurality of events specified by the monitoring module.

6. The method of claim 1, wherein the action is taken if the specified event is true.

7. The method of claim 1, further comprising invoking the specified function in a loop.

8. The method of claim 1, further comprising:
invoking a script in a startup directory; re-reading and parsing the configuration file in accordance with the defined syntax;
setting a plurality of variables in accordance with the specification of the monitoring module;
executing the monitoring function as specified in the monitoring module; and
executing the validation function upon instantiation of the variables.

9. The method of claim 1, further comprising:
re-reading the configuration file in accordance with the scripting;
setting a plurality of variables in accordance with the specification of the monitoring module;
executing the monitoring function as specified in the monitoring module; and
executing the validation function upon instantiation of the variables.

10. The method of claim 1, wherein the re-read is triggered by trapping a HUP signal.

11. The method of claim 1, wherein setting the plurality of variables includes setting a plurality of Korn shell variables.

12. The method of claim 1, wherein scripting the read of the configuration file includes inserting a new script or modifying an existing script.

13. The method of claim 1, wherein the identified location is a relative directory.

14. The method of claim 13, further comprising instantiating the relative directory.

15. The method of claim 1, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

16. A computing device programmed to perform a method for use in monitoring the operation of a computing system, the computing device comprising:
means for defining a monitoring module in a configuration file, the monitoring module definition specifying, according to a predefined syntax:
a module name identifying a location;
a monitoring function to be executed at a period;
an event triggering the monitoring function; and
an action to be taken depending on the outcome of the event;
means for encoding a monitoring module into a storage at the identified location, including:
encoding a validation function; and
encoding the monitoring function; and
means for scripting a read of the configuration file.

17. The computing device of claim 16, further comprising:
means for invoking a script in a startup directory;
means for re-reading and parsing the configuration file in accordance with the defined syntax;
means for setting a plurality of variables in accordance with the specification of the monitoring module;
means for executing the monitoring function as specified in the monitoring module; and
means for executing the validation function upon instantiation of the variables.

18. The computing device of claim 16, further comprising:
means for re-reading the configuration file in accordance with the scripting;
means for setting a plurality of variables in accordance with the specification of the monitoring module;
means for executing the monitoring function as specified in the monitoring module; and
means for executing the validation function upon instantiation of the variables.

19. The computing device of claim 16, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

20. A program storage medium encoded with instructions that, when executed by a computing device, perform a method for use in monitoring the operation of a computing system, the encoded method comprising:
defining a monitoring module in a configuration file, the monitoring module definition specifying, according to a predefined syntax:
a module name identifying a location;
a monitoring function to be executed at a period;
an event triggering the monitoring function; and
an action to be taken depending on the outcome of the event;
encoding a monitoring module into a storage at the identified location, including:
encoding a validation function; and
encoding the monitoring function; and
scripting a read of the configuration file.

21. The program storage medium of claim 20, wherein the encoded method further comprises:
invoking a script in a startup directory;
re-reading and parsing the configuration file in accordance with the defined syntax;
setting a plurality of variables in accordance with the specification of the monitoring module;
executing the monitoring function as specified in the monitoring module; and
executing the validation function upon instantiation of the variables.

22. The program storage medium of claim 20, wherein the encoded method further comprises:
re-reading the configuration file in accordance with the scripting;
setting a plurality of variables in accordance with the specification of the monitoring module;
executing the monitoring function as specified in the monitoring module; and
executing the validation function upon instantiation of the variables.

23. The program storage medium of claim 20, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

24. A computing device programmed to perform a method for use in monitoring the operation of a computing system, the programmed method comprising:
defining a monitoring module in a configuration file, the monitoring module definition specifying, according to a predefined syntax:
a module name identifying a location;
a monitoring function to be executed at a period;
an event triggering the monitoring function; and
an action to be taken depending on the outcome of the event;
encoding a monitoring module into a storage at the identified location, including:
encoding a validation function; and
encoding the monitoring function; and
scripting a read of the configuration file.

25. The computing device of claim 24, wherein the programmed method further comprises:
invoking a script in a startup directory;
re-reading and parsing the configuration file in accordance with the defined syntax;
setting a plurality of variables in accordance with the specification of the monitoring module;
executing the monitoring function as specified in the monitoring module; and
executing the validation function upon instantiation of the variables.

26. The computing device of claim 24, wherein the programmed method further comprises:
re-reading the configuration file in accordance with the scripting;
setting a plurality of variables in accordance with the specification of the monitoring module;
executing the monitoring function as specified in the monitoring module; and
executing the validation function upon instantiation of the variables.

27. The computing device of claim 24, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

28. A computing system, comprising:
a configuration file;
a monitoring module definition encoded in the configuration file, the monitoring module definition specifying, according to a predefined syntax:
a module name identifying a location;
a monitoring function to be executed at a period;
an event triggering the monitoring function; and
an action to be taken depending on the outcome of the event;
a monitoring module at the identified location, including:
en coding a validation function; and
encoding the monitoring function; and
a script directing a read of the configuration file.

29. The computing system of claim 28, wherein the computing system comprises a network.

30. The computing system of claim 28, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

31. A framework for monitoring and controlling the operation of a computing system, comprising:
a configuration file including a plurality of monitoring module definitions, each monitoring module definition specifying according to a predefined syntax:
a module name;
a monitoring function to be executed at a period;
at least one event triggering the monitoring function; and
an action to be taken depending on the outcome of the event;
a plurality of monitoring modules, each monitoring module encoded at a location by a respective one of the specified module names in the monitoring module definitions, each monitoring module including:
a validation function; and
the respective monitoring function specified by the respective monitoring module; and
a script directing a read of the configuration file.

32. The framework of claim 31, wherein at least one of the monitoring module definition specifies the period.

33. The framework of claim 31, wherein at least one of the monitoring module definition definitions further specifies a threshold.

34. The framework of claim 33, wherein the threshold is hardcoded or calculated on the fly by a called function.

35. The framework of claim 31, wherein at least one of the events comprises one of a plurality of events specified by one of the monitoring module.

36. The framework of claim 31, wherein at least one of the actions is taken if the respective specified event is true.

37. The framework of claim 31, wherein the script directs the read of the configuration file upon invocation or the trap of a HUP signal.

38. The framework of claim 31, wherein script comprises a new script or a modified script.

39. The framework of claim 31, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################

40. A method for monitoring the operation of a computing system, comprising:
reading a configuration file including at least one monitoring module definition according to a predefined syntax;
setting a plurality of variables in accordance with the specification of the monitoring module definitions; and
executing a monitoring module defined by the monitoring module definition, including:
executing a monitoring function specified by the monitoring module definition from within the monitoring module upon the occurrence of an event specified in the monitoring module definition; and
executing a validation function from within the monitoring module upon instantiation of the variables.

41. The method of claim 40, wherein the monitoring module definition specifies the period.

42. The method of claim 40, wherein the monitoring module definition further specifies a threshold.

43. The method of claim 40, wherein the event comprises one of a plurality of events specified by the monitoring module.

44. The method of claim 40, further comprising executing a script directing a read of the configuration file.

45. The method of claim 40, wherein the identified location is a relative directory.

46. The method of claim 40, wherein the predefined syntax is:

| ############################# | |
|---|---|
| Module | Begin |
| Name | <module_name> |
| Monitor | <monitor_func> |
| Period | <period> |
| Event | <event> |
| Action | <action_func> |
| Module | End |

#############################
